(19) United States
(12) Patent Application Publication
(10) Pub. No.: US 2013/0144712 A1
(43) Pub. Date: Jun. 6, 2013

(54) SYSTEMS AND METHODS FOR GROUP DELIVERY, GROUP COUNTING AND GROUP PACING OF AD DELIVERY ON THE WORLD WIDE WEB

(71) Applicants: Fernando Ruarte, San Francisco, CA (US); Samir Arora, Woodside, CA (US); Arthur Schram, Davis, CA (US); Jamie Maddaloni, San Francisco, CA (US); Bryan Beresford, Redwood City, CA (US); Lindsey Frankenfield, Oakland, CA (US); Anne Farmer, Oakland, CA (US); Bao-Long Nguyen-Trong, Alameda, CA (US); Abhijeet Shah, Pune (IN); Ashok Srinivas, Pune (IN); Darshana Munde, Pune (IN)

(72) Inventors: Fernando Ruarte, San Francisco, CA (US); Samir Arora, Woodside, CA (US); Arthur Schram, Davis, CA (US); Jamie Maddaloni, San Francisco, CA (US); Bryan Beresford, Redwood City, CA (US); Lindsey Frankenfield, Oakland, CA (US); Anne Farmer, Oakland, CA (US); Bao-Long Nguyen-Trong, Alameda, CA (US); Abhijeet Shah, Pune (IN); Ashok Srinivas, Pune (IN); Darshana Munde, Pune (IN)

(21) Appl. No.: 13/489,666

(22) Filed: Jun. 6, 2012

Related U.S. Application Data
(60) Provisional application No. 61/494,109, filed on Jun. 7, 2011.

(51) Int. Cl. G06Q 30/02

(52) U.S. Cl. CPC G06Q 30/0277; G06Q 30/0246
USPC 705/14.45; 705/14.73

(57) ABSTRACT

Through the utilization of group delivery, group counting and group pacing, an ad serving platform treats a grouping of ads as a standard unit despite the multiple ad unit components. The ad server platform paces and manages the flight of that grouped set of ads as a single entity. The ad server platform guarantees quality of delivery by only counting a qualified impression event when the group delivery has been successful, thereby opening this type of highly impactful advertising experience up to non-standard inventory sources, rather than relying on highly controlled content environments.

### PRIORITY CLAIM

This application claims the benefit of U.S. Provisional Application No. 61/494,109, filed on Jun. 7, 2011, by Ruarte et al. and titled “Group Delivery and Conditional Counting.” Provisional Application No. 61/494,109 is hereby incorporated by reference herein in its entirety.

### FIELD OF THE INVENTION

The present invention relates to delivery of advertising to the world wide web (Web) and, in particular, to systems and methods for group delivery, group counting and group pacing of ad delivery, which serve to both deliver ads collectively on a page view and then count them as a single unified ad experience, but only counting them when a takeover has been successful. Although not intended to be limiting of the invention, it is noted that these systems and methods are particularly impactful in the context of a distributed network of digital properties, where the owner of the ad delivery is not in full control of the environment in which the ads are being called, and there is a greater likelihood of external factors impacting successful delivery.

### BACKGROUND OF THE INVENTION

Websites and other digital content destinations on the Web often contain numerous discreet places for advertising to be inserted. In the case of a standard Web page, these places usually take the form of banner ad placements, but they can also include pre-roll video advertising placements, for example.

Most ad serving systems treat these ad placements on a given page load separately, delivering advertising to them based upon diverse optimization and/or targeting parameters.

To achieve maximum advertiser impact on a page, it can be desirable to treat all placements on a given page collectively, and deliver advertising to all of those placements simultaneously. This type of advertising experience (typically called a “takeover” or a “roadblock”) is achievable to some degree with most ad serving solutions. However, the way it is delivered is limited both in terms of delivery flexibility and in terms of providing an accurate count of a delivery for which an advertiser is paying.

### SUMMARY OF THE INVENTION

Through the utilization of group delivery, group counting and group pacing, an ad serving platform treats a grouping of ads as a standard unit despite the multiple ad unit components. The ad server system paces and manages the flight of that grouped set of ads as a single entity. The ad server platform guarantees quality of delivery by only counting a qualified impression event when the group delivery has been successful, thereby opening this type of highly impactful advertising experience up to non-standard inventory sources, rather than relying on highly controlled content environments.

The features and advantages of the various aspects of the subject matter disclosed herein will be more fully understood and appreciated upon consideration of the following detailed description and accompanying drawings, which set forth illustrative embodiments in which the concepts of the claimed subject matter are utilized.

### BRIEF DESCRIPTION OF THE DRAWINGS

FIG. 1 provides a screen shot illustrating multiple ad units on a standard Web page.

FIG. 2 is a screen shot illustrating multiple coordinate ad units on a Web page.

FIG. 3 is a logic flow diagram illustrating ad group delivery flow.

FIG. 4 is a logic flow diagram illustrating the definition of when an ad impression is recorded if a group with three ads is being served.

FIG. 5 is logic flow diagram illustrating an example of no qualifying event occurring and no impression being recorded.

FIG. 6 is a system block diagram illustrating an ad selection system architecture in accordance with an embodiment of the present invention.

FIG. 7 is system flow diagram illustrating first ad selection within a group of ads in an ad selection system architecture in accordance with an embodiment of the present invention.

FIG. 8 is a system flow diagram illustrating second ad selection within a group of ads in an ad selection system architecture in accordance with an embodiment of the present invention.

FIG. 9 is a system flow diagram illustrating first ad selection within a group of ads with conditional counts after two impressions in an ad selection system in accordance with an embodiment of the present invention.

FIG. 10 is a system flow diagram illustrating second ad selection within a group of ads with conditional counts after two impressions in an ad selection system in accordance with an embodiment of the present invention.

### DETAILED DESCRIPTION

Ad serving systems and methods in accordance with the present invention solve the above-described problems utilizing three directly related aspects, hereinafter referred to as group delivery, group counting and group pacing, that serve to both deliver ads collectively on a page view, and then count the delivered ads as a unified ad experience, only counting when the takeover has been successful.

Group Delivery

In accordance with an aspect of the invention, when an ad request is made by an ad server ad tag, the request is “conscious” of whether it is the first request on a page and is able to set a page-level parameter that is visible to all other ad tag requests on the page. This page-level parameter can be set as “exclusive” or “non-exclusive” depending upon the scenario. However, in the event that the page-level parameter is set as exclusive, then all ads targeted to the page will be automatically selected regardless of additional criteria. This allows the ensured delivery of a collection of “grouped” ads on a given page.

Group Counting

Especially in a distributed media setting, where the layout and makeup of the content environment can change rapidly, it is assumed that not all takeover advertising experiences will deliver to their full and desired impact on every load for every user. For example, a Website may decide in the middle of a day to restrict advertising on its homepage to a single 300×250 medium rectangle banner unit. However, the ad platform is not aware of this change. Although the ad server system will rebuild its map of a page dynamically as elements change, this sudden change may lead to an impression where it is not possible for the takeover experience that an advertiser paid for to be delivered. In accordance with an aspect of the invention, in the context of group delivery, the ad server system can be set to count a single unified page-level impression only when certain conditions are met, thereby ensuring the purchased number of full-page experiences are actually delivered during a campaign.

Group Pacing

In accordance with an aspect of the invention, although individual ads continue to be counted and increment counters are used for ad pacing (the even delivery of ads to a particular flight/campaign goal), in the context of group counting, an ad must be paced to the group count, while maintaining individual ad counters.

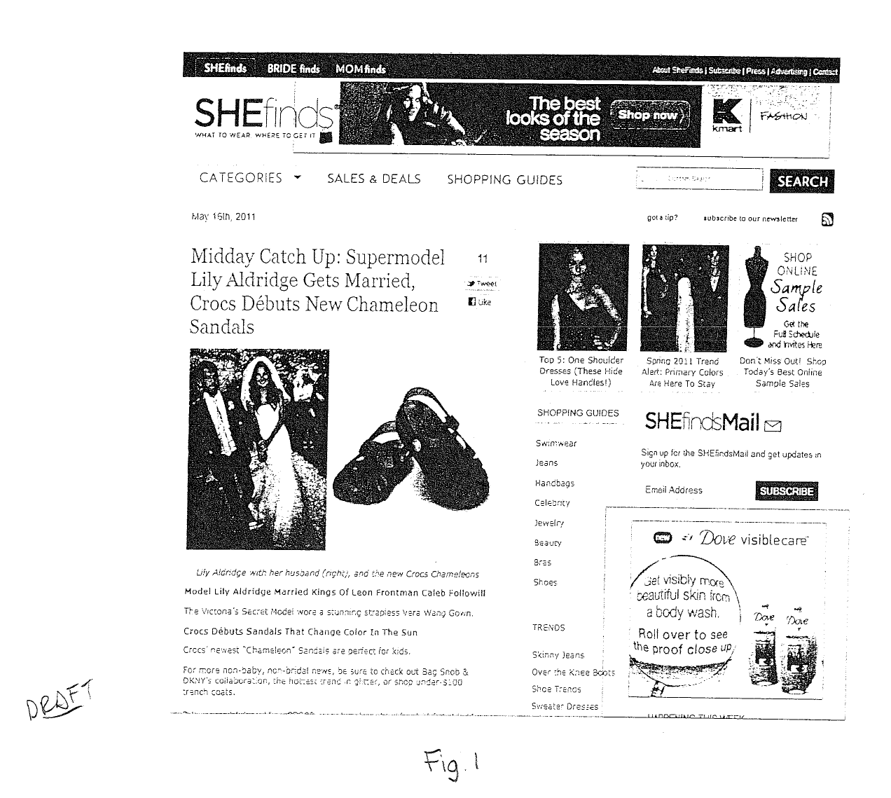

As shown in the FIG. 1 screenshot, multiple digital ad units may be present on a standard Web page.

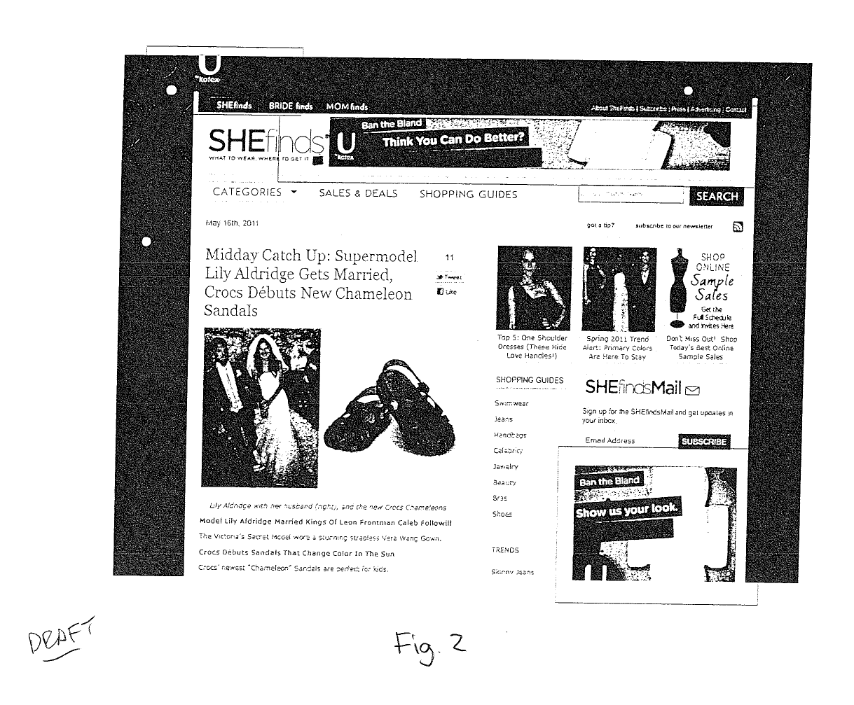

The FIG. 2 screenshot shows multiple coordinated digital ad units, including the background of the site, that are all involved in a coordinated ad display.

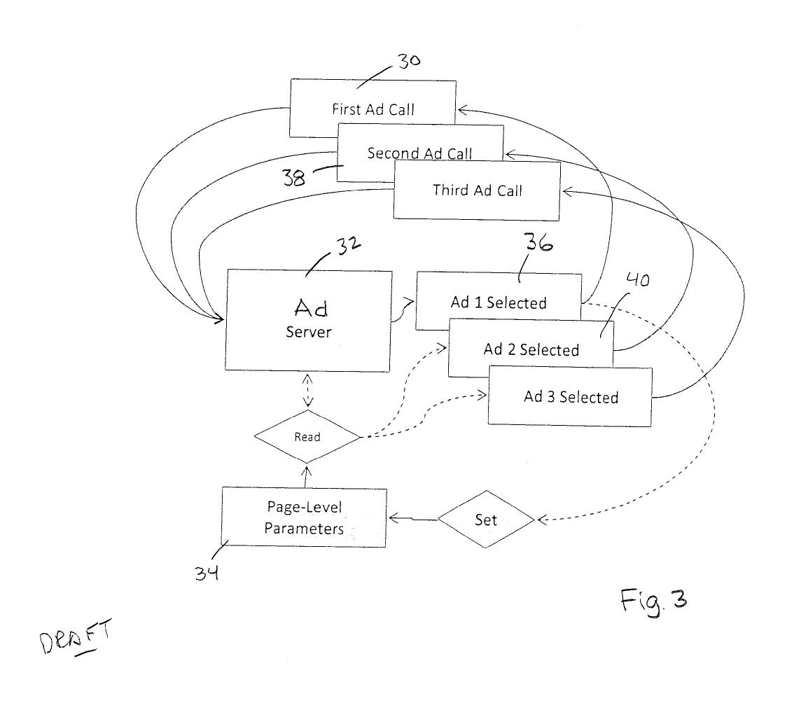

FIG. 3 shows an ad group delivery flow diagram, including how page-level parameters are set through ad selection and then used for ad selection. As shown in the FIG. 3 flow diagram, a first ad call 30 is made from a specific user session (page load). An ad server 32 reads pre-existing page level parameters 34 to determine if the scenario is appropriate for grouped ad delivery, for example, confirming that the ad is indeed the first to be selected on the page. The selection of the first ad 36 sets a page-level parameter 34 that is an attribute of the ad 36. The second ad call 38 is made and again the ad server 32 reads from page-level parameters 34 associated with the specific page load. The second ad 40 is then selected. The selection of the second ad is affected by the page-level parameters 34. Based upon the particular configuration of the parameters set by the first ad 36, the second ad 40 may be forced to be selected or simply influenced in it selection. As shown in FIG. 3, the process continues for as many ad calls as are made by the page load.

For group counting based upon the scenario outlined in the FIG. 3 flow diagram, the following flow/methodology is implemented. Initially, the ads that are expected to participate in the grouped delivery are grouped logically under a single group ID. Next, a “counter type” is defined, to set the definition of an ad impression for the group. The counter type will be one of three options: (a) count an impression for every individual ad delivered, (b) count a single page-load-level impression when all ads from the group are selected together, and (c) count a single page-load level impression when a minimum threshold of the ads from the group is selected together. The first option (a) above is an election to use group delivery without group counting, since all ad impressions are counted. Options (b) and (c) above will now be outlined to describe an aspect of the invention. In both instance (b) and instance (c), a maximum of one impression will be counted per page load.

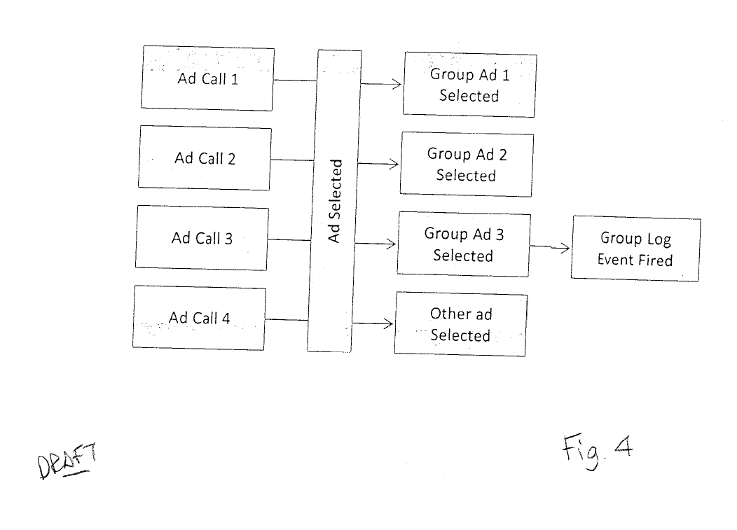

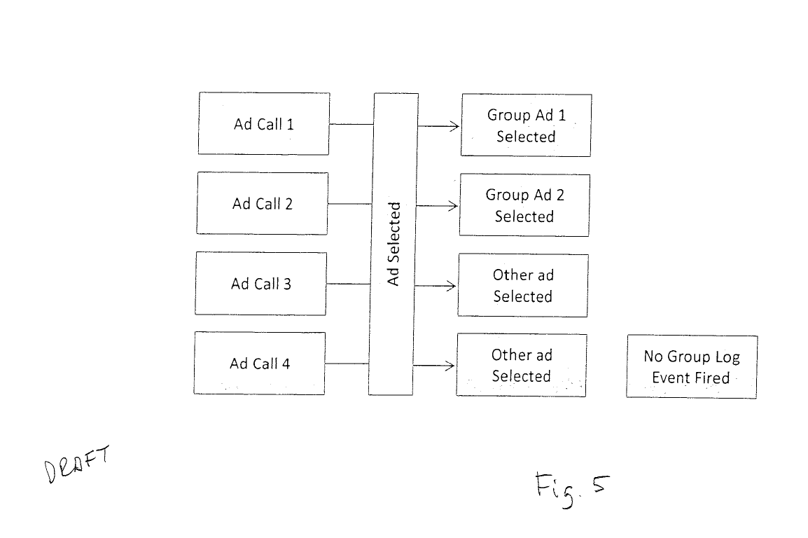

The flow for option (b) requires that all ads from the group must be selected: ads in the group=3; ad calls on the page=4. Referring to FIGS. 4 and 5, the triggering of a qualifying log event is based upon a threshold of ads from the group of ads that are successfully selected to show on the page. The counter type in the event of the examples above is defined as all ads from the group must be selected for a group impression to be counted. Since there are three ads in the group, in the FIG. 4 scenario, the qualifying log event is triggered when the third ad from the group is displayed. In the FIG. 5 scenario, only two ads from the group have been selected and the subsequent ad calls select ads that are not a part of the group. Therefore, in the FIG. 5 scenario, no threshold is met and the group impression count is never triggered.

The same logic applies to option (c) above. However, rather than the threshold to trigger a group count being defined by the total number of ads in the group, the threshold is freely selected by the user setting up the ads.

As stated above, group pacing involves the ability to treat the campaign flighting and pacing of an ad group the same way that a single ad would be treated. Because the pacing of an ad in an ad server relies on reading and incrementing real-time counts in data cache servers, it is critical that for pacing to a group goal (for example, “evenly deliver 250,000 qualified group experiences evenly across ad inventory for three days”), the qualified impression event be able to technologically increment a data caching server's counter, so that it can follow standard pacing behavior.

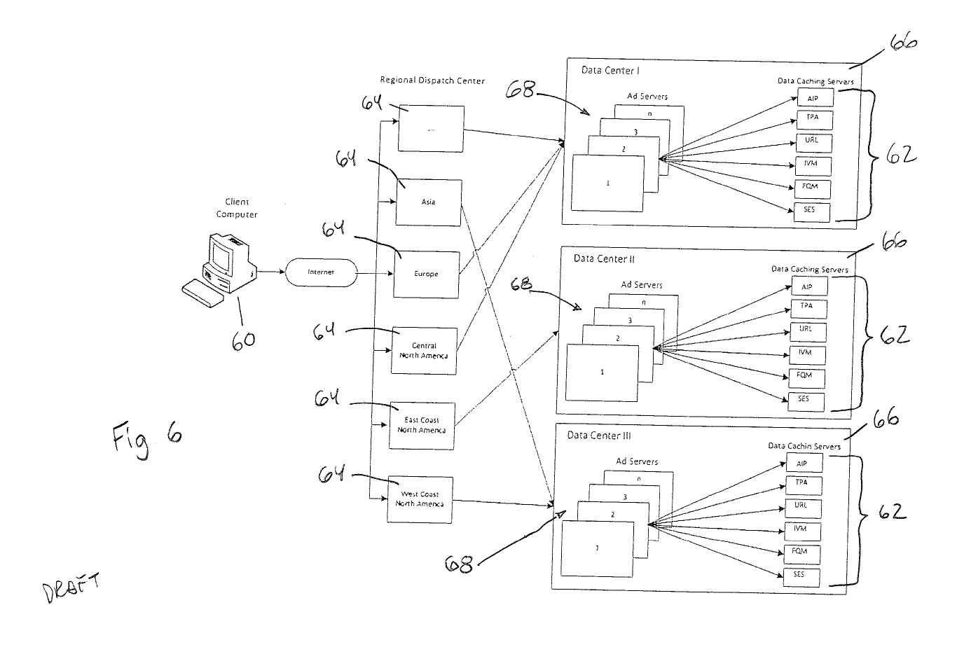

The FIG. 6 system architecture diagram shows an embodiment of an ad selection architecture from a client computer 60 to data caching servers 62. In the FIG. 6 embodiment, the ad selection system sets and reads in values from six different data caching server installations 62 per data center 64. Each data caching server 62 within a data center 64 is specialized to avoid corruption or major loss of information across diverse processes in the event of failure in a specialized process.

As shown in the FIG. 6 diagram, each request via the Internet from a client computer 60 is processed via a regional dispatch center and directed to a given data center 66. Each data center 66 contains a plurality of ad servers 68 (1, 2, 3, . . . , n) which process the ad selection logic, and data caching servers (DCS) 62 which manage volatile information using fast, transactional in memory storage software such as, for example, memcache.

In the FIG. 6 embodiment, for each ad serving request received by the ad servers 68, the server 68 opens a connection with six DCSs 62, each of which contains critical information required during the selection of an ad:
1. AIP (Ads Impressions Pacer)—Contains the counters for every single ad as well as the pacing objectives for every ad over each time window of the day.
2. TPA (Transient Processing Area)—Contains the information regarding the ads delivered for every single page view happening on every single url on the network.
3. UR—Contains the characteristics of every ad placement on every url, such as ad size, x-y coordinates, performance indicators, etc.
4. FQM (Frequency Manager)—Contains the information about ad view counts for each end user unique visitor session, to be used for Frequency Capping of ads.
5. IVM (Inventory Manager)—Contains information about ad inventory objectives for each publisher site on the network, to be used for prioritization of the fill rate of sites.
6. SES (Session Manager)—Contains information about the end user such as categories of ads viewed, engagement performance, etc. This data is to be used for ad targeting purposes only and does not contain or relate to any personally identifiable information.
   As it relates to group delivery of ads, the key data caching servers are TPA and URL.

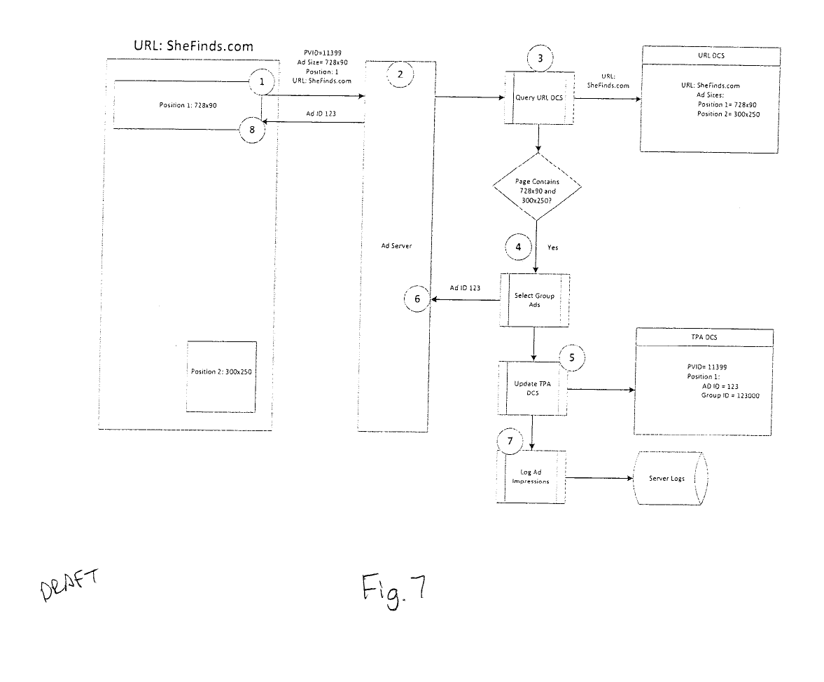

Referring to FIG. 7, on the first ad call of the page, the ad server queries the URL DCS to determine the characteristics of the specific page url that the end user is browsing. If the data from the URL DCS shows that the placements on that url satisfy the targeting criteria of the primary ad (4), then the ad is selected that indicates that this is the first ad that belongs to a group. The ad server then saves the relevant information for this ad and the group id in the TPA DCS record associated with the unique id for that page view.

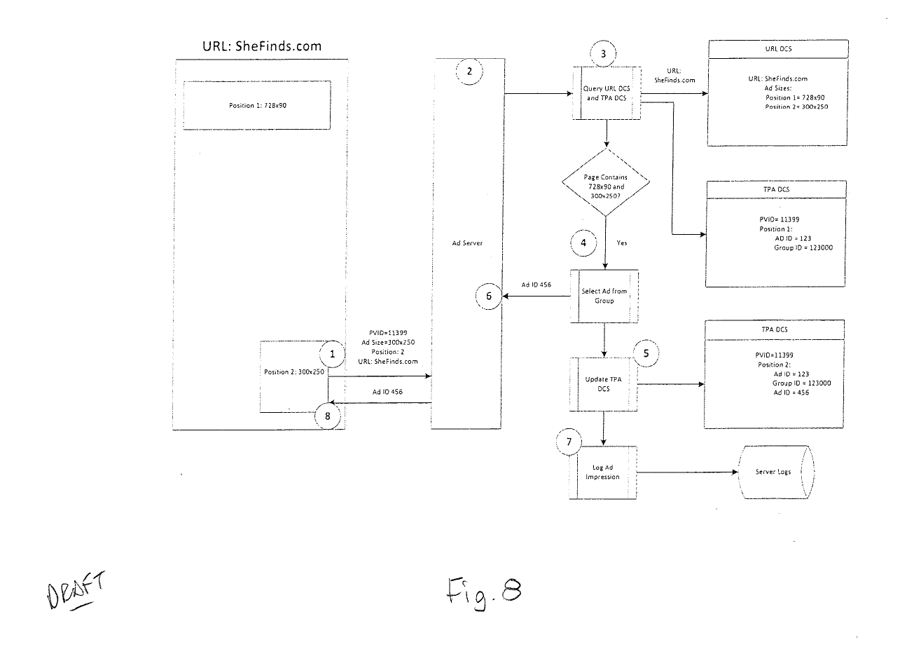

Referring to FIG. 8, When the next ad call is made from the page, the ad server queries both the URL DCS and the TPA DCS. The TPA data for this page now indicates that an ad that contains two ad sizes was previously selected on this page, so the ad selection process should select an ad from that group.

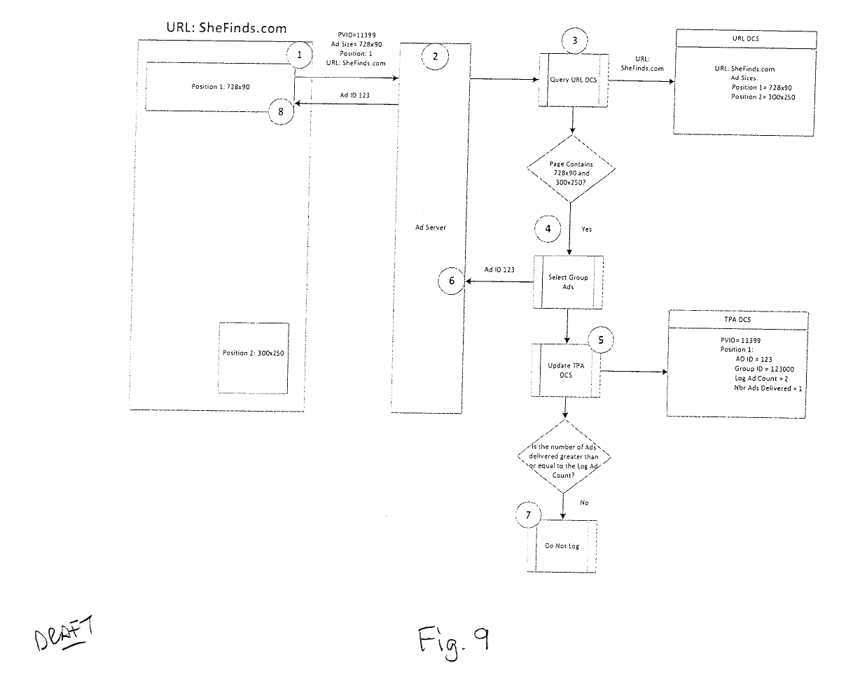

The logic for conditional counting builds on the concepts described above. FIG. 9 shows an embodiment of the processing flow during two ad selections with conditional group count. When a group is set to count the impression only upon a certain number of ads being delivered on the page, the group has a field called LogAdCount. This field is also saved in the TPA DCS for each page view and is used to dictate processing flow during two ad selections with conditional group count.

As shown in FIG. 9, after delivering the first ad impression of the group, the number (Nbr) of ads delivered on the page is 1 with a LogAdCount of 2. The impression is not logged since the threshold is not being met.

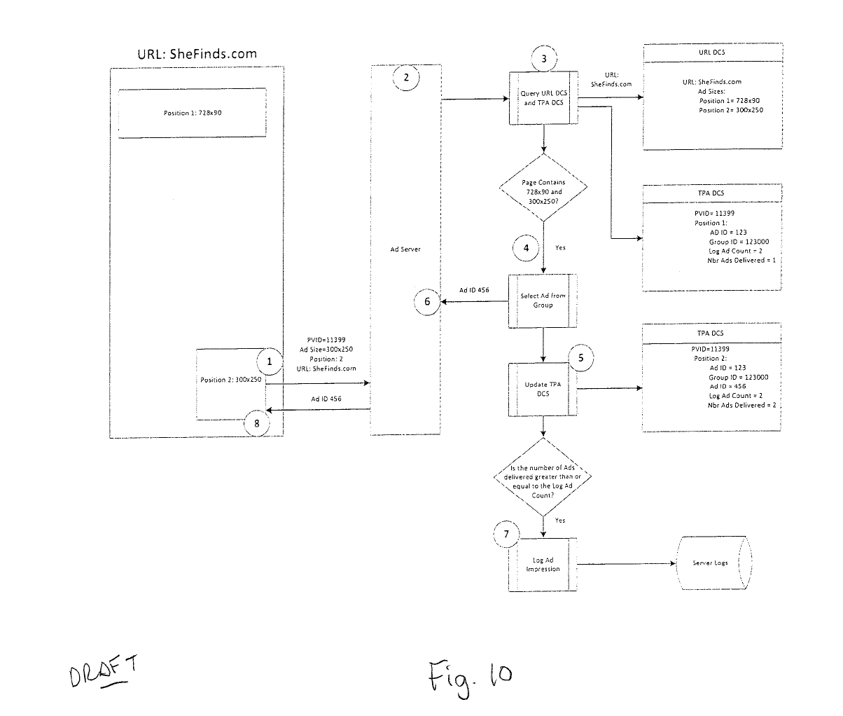

FIG. 10 shows second ad selection within a group with conditional counts after 2 impressions. This time, after delivering the second ad impression, the LogAdCount for the group was met and the impression was therefore counted and logged.

It should be understood that the particular embodiments of the invention described herein have been provided by way of example and that other modifications may occur to those skilled in the art without departing from the scope of the claimed subject matter as expressed in the appended claims and their equivalents.

What is claimed is:

1. A computer-implemented method of group ad delivery, the method comprising:
utilizing an ad server system to make an ad request by an ad server tag, the request being conscious of whether it is the first ad request on a page;
setting a page-level parameter that is visible to all other ad tag requests on the page, the page-level parameter being set as either exclusive or non-exclusive;
in the event that the page-level parameter is set as exclusive, then selecting all ads targeted to the page automatically regardless of additional criteria, thereby ensuring delivery of a collection of grouped ads on a given page.

2. The method of claim 1, further comprising:
setting the ad server system to count a single unified page-level impression only when defined conditions are met, thereby ensuring that a defined number of full-page experiences is actually delivered during an ad campaign.

3. The method of claim 2, further comprising:
while individual ads continue to be counted and increment counters are used for ad pacing, pacing an ad to a group count, while maintaining individual ad counters.

4. An ad server system that includes an ad server that makes an ad request utilizing an ad server tag, the request being conscious of whether it is the first ad request on a page, wherein the ad server sets a page-level parameter that is visible to all other ad tag requests on the page, the page-level parameter being set as either exclusive or non-exclusive, and wherein, in the event that the page-level parameter is set as exclusive, the ad server system selects all ads targeted to the page automatically regardless of additional criteria, thereby ensuring delivery of a collection of grouped ads on a given page.

5. The ad server system of claim 4, wherein the ad server system is set to count a single unified page-level impression only when defined conditions are met, thereby ensuring that a defined number of full-page experiences is actually delivered during an ad campaign.

6. The ad server system of claim 5, wherein the ad server system continues to count individual ads and increment counters are used for ad pacing, the ad server system pacing an ad to a group count, while maintaining individual counters.
